(19) United States
(12) Patent Application Publication
(10) Pub. No.: US 2021/0315042 A1
(43) Pub. Date: Oct. 7, 2021

(54) FAST REASSOCIATION WITH AN ACCESS POINT

(71) Applicants: Ido Ouzieli, Tel Aviv (IL); Ofer HAREUVENI, Haifa (IL); Johannes Berg, Detmold (DE); Emily H. Qi, Gig Harbor, WA (US)

(72) Inventors: Ido Ouzieli, Tel Aviv (IL); Ofer HAREUVENI, Haifa (IL); Johannes Berg, Detmold (DE); Emily H. Qi, Gig Harbor, WA (US)

(21) Appl. No.: 17/349,001

(22) Filed: Jun. 16, 2021

Related U.S. Application Data
(60) Provisional application No. 63/039,587, filed on Jun. 16, 2020.

(51) Int. Cl. H04W 76/19; H04W 48/20; H04W 12/069; H04W 12/041; H04W 48/16

(52) U.S. Cl. CPC H04W 76/19; H04W 48/20; H04W 84/12; H04W 12/041; H04W 48/16; H04W 12/069

(57) ABSTRACT

Methods, apparatuses, and computer readable media for fast reassociation with an access point (AP) are disclosed. Apparatuses of an AP are disclosed, where the apparatuses comprise processing circuitry configured to decode a reassociation request frame from the station (STA), encode for transmission to the STA a reassociation response frame, in response to the reassociation request frame being a protected reassociation frame, and encode for transmission to the STA a security association (SA) query frame, in response to the reassociation request frame not being the protected reassociation frame. Apparatuses of an STA are disclosed where the apparatuses comprise processing circuitry configured to associate with an AP, encode for transmission to the AP a protected reassociation request frame, and deleting keys and performing a 4-way handshake with the AP to generate new keys, in response to receiving a reassociation response frame indicating a successful reassociation with the AP.

### PRIORITY CLAIM

This application claims the benefit of the priority under 35 U.S.C. 119(e) to U.S. Provisional Patent Application Ser. No. 63/039,587 filed Jun. 16, 2020, which is incorporated herein by reference in its entirety.

### TECHNICAL FIELD

Embodiments relate to fast reassociation with an access point (AP) operating in accordance with wireless local area networks (WLANs) and Wi-Fi networks including networks operating in accordance with different versions or generations of the IF EE 802.11 family of standards. Some embodiments relate to transmitting reassociation and association frames using encryption.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols, and wireless devices may need to operate with more than one frequency band.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates a method 800 for association or reassociation with an AP, in accordance with some embodiments;

FIG. 9 illustrates a method of fast association or reassociation with an AP, in accordance with some embodiments;

FIG. 10 illustrates a management frame, in accordance with some embodiments;

FIG. 11 illustrates robust security network extension element (RSNXE) format, in accordance with some embodiments;

FIG. 12 illustrates a method of fast association or reassociation with an AP, in accordance with some embodiments; and

FIG. 13 illustrates a method of fast association or reassociation with an AP, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments relate to methods, computer readable media, and apparatus for ordering or scheduling location measurement reports, traffic indication maps (TIMs), and other information during SPs. Some embodiments relate to methods, computer readable media, and apparatus for extending TIMs. Some embodiments relate to methods, computer readable media, and apparatus for defining SPs during beacon intervals (BI), which may be based on TWTs.

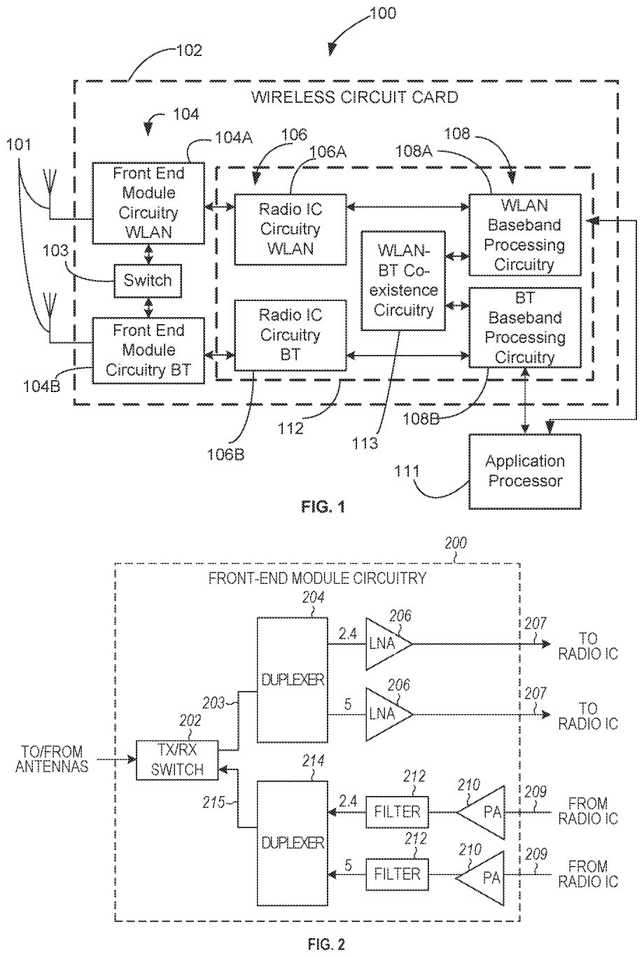

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

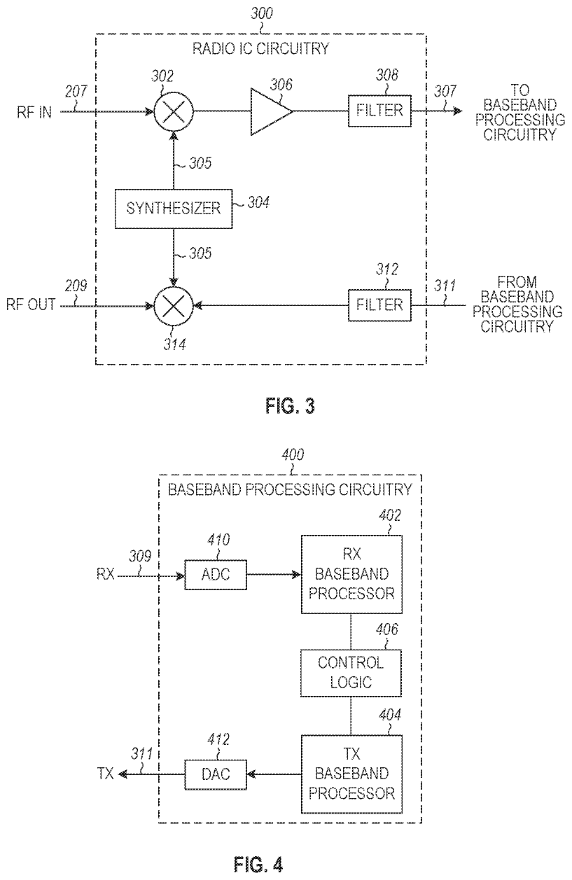

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ABC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

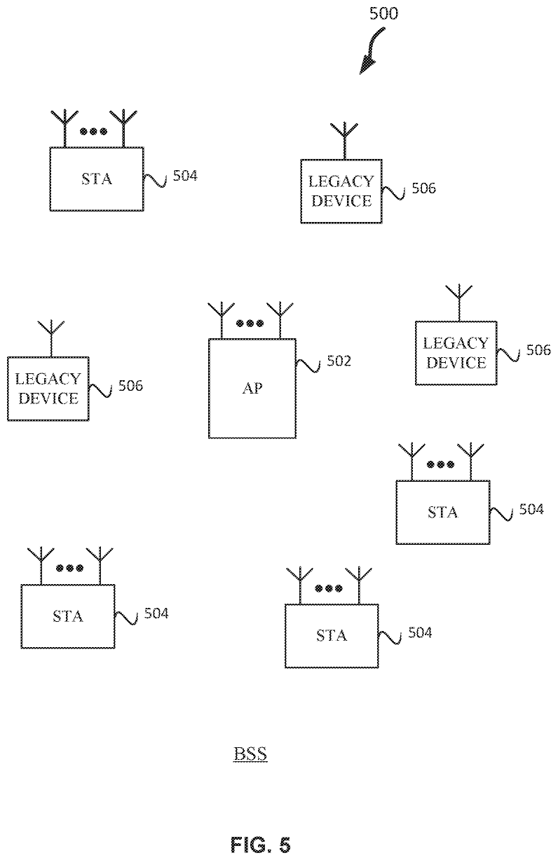

FIG. 5 illustrates a WLAN 500 in accordance with some embodiments. The WLAN 500 may comprise a basis service set (BSS) that may include an access point (AP) 502, a plurality of stations (STAs) 504, and a plurality of legacy devices 506. In some embodiments, the STAs 504 and/or AP 502 are configured to operate in accordance with IEEE 802.11be extremely high throughput (EHT) and/or high efficiency (HE) IEEE 802.11ax. In some embodiments, the STAs 504 and/or AP 520 are configured to operate in accordance with IEEE 802.11az. In some embodiments, IEEE 802.11EHT may be termed Next Generation 802.11.

The AP 502 may be an AP using the IEEE 802.11 to transmit and receive. The AP 502 may be a base station. The AP 502 may use other communications protocols as well as the IEEE 802.11 protocol. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the H AP 502 may also be configured to communicate with STAs 504 in accordance with legacy IEEE 802.11 communication techniques.

In some embodiments, a HE or EHT frames may be configurable to have the same bandwidth as a channel. The HE or EHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPM, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80±80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 IX, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

In accordance with some IEEE 802.11 embodiments, e.g, IEEE 802.11EHT/ax embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE or EHT control period, the AP 502 may communicate with stations 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or LT OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/ax communication techniques, although this is not a requirement.

In some embodiments the STA 504 may be a “group owner” (GO) for peer-to-peer modes of operation. A wireless device may be a STA 502 or a HE AP 502.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE station 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-13.

In example embodiments, the STAs 504 and/or the HE AP 502 are configured to perform the methods and operations/functions described herein in conjunction with FIGS. 1-13. In example embodiments, an apparatus of the STA 504 and/or an apparatus of the AP 502 are configured to perform the methods and functions described herein in conjunction with FIGS. 1-13. The term Wi-Fi may refer to one or more of the IEEE 802.11 communication standards. AP and STA may refer to EHT/HE access point and/or EHT/HE station as well as legacy devices 506.

In some embodiments, a HE AP STA refers to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP.

In some embodiments, a physical layer protocol data unit (PPDU) may be a physical layer conformance procedure (PLOP) protocol data unit (PPDU). In some embodiments, the AP 502 and STAs 504 may communicate in accordance with one of the IEEE 802.11 standards such as 11be, 11r, 11i, and/or 11w. IEEE P802.11be™/D1.0, May 2021, IEEE P802.11, December 2020, and IEEE P802.11ax are incorporated herein by reference.

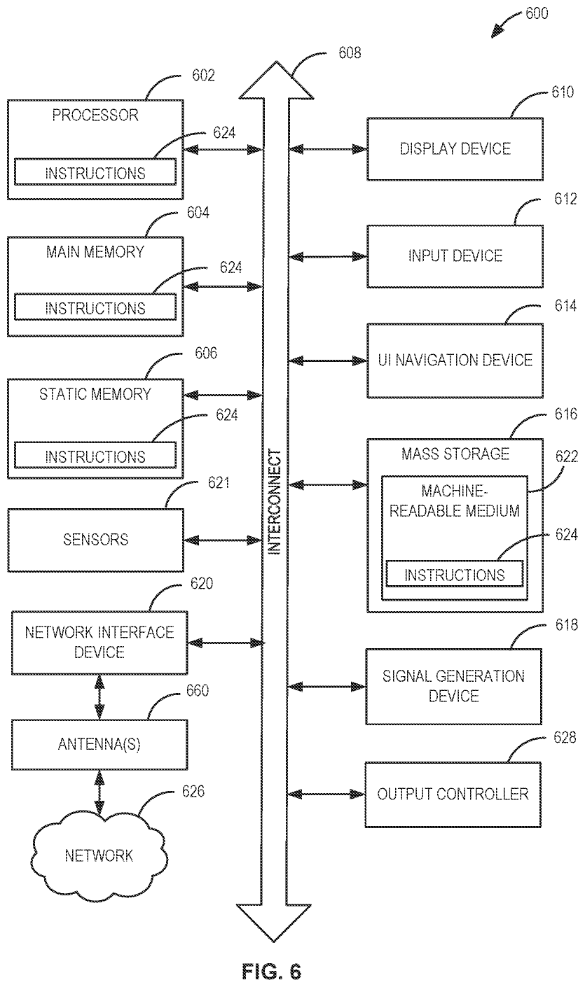

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT station 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UT navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, interne protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

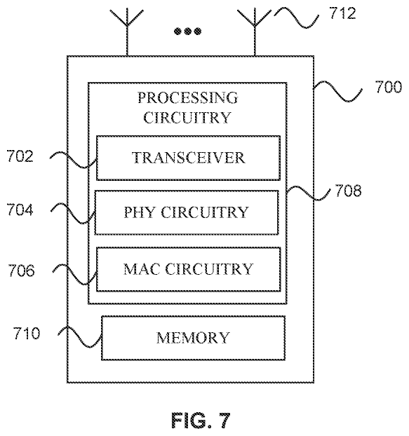

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the HE stations 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

A technical problem is how a STA 504 can associate or reassociation with an AP 502 efficiently or faster than current methods and protect against man-in-the-middle attacks or other types of attacks. The STA 504 may want to a new association process with an AP 504 with which it is already associated. For example, the AP 502 that the STA 504 is associated with may switch to a new band where new capabilities are available that were not originally negotiated. In another example, environmental changes may require updates in existing capabilities such as the bandwidth. In another example, reassociation may be needed/required during active data streaming sessions between the AP 502 and the STA 504 and the reassociation should have minimal impact on traffic latency and packet loss to maintain an acceptable quality of service. In some embodiments, the reassociation or association needs to be as fast or faster than the STA 504 roaming to a new AP 502. In some embodiments, the technical problem is solved by enabling the reassociation or association request to be encrypted or protected using protected management frames (PMFs), e.g., in accordance with IEEE 802.11w. Management frame transmitted in accordance with PMF are termed robust management frames, in accordance with some embodiments. The AP 502 can verify that the association or reassociation frame is from the STA 504 in accordance with PMF protocols and the time to encode and decode the PMFs is less than methods that rely on timeouts.

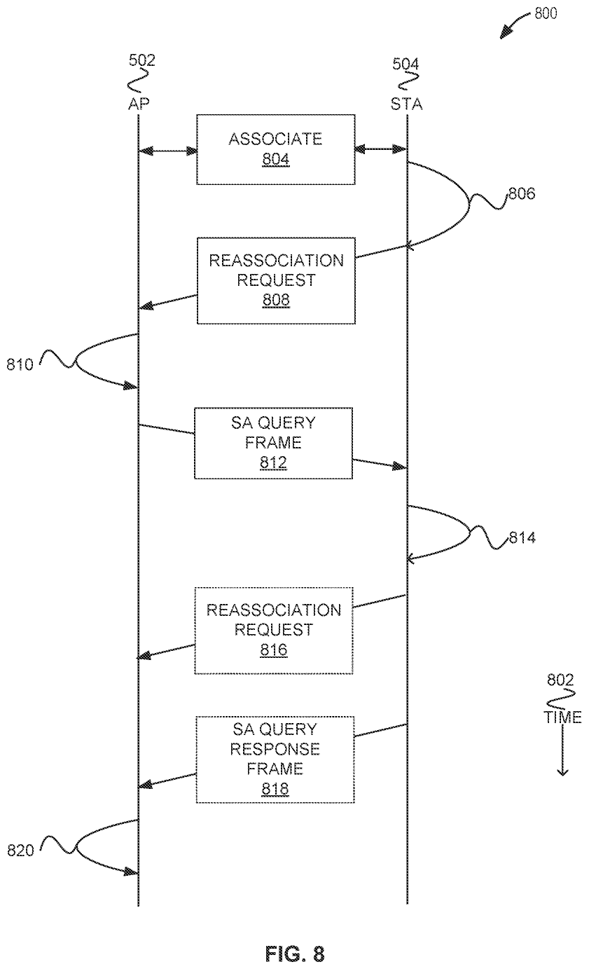

FIG. 8 illustrates a method 800 for association or reassociation with an AP 502, in accordance with some embodiments. Time 802 progresses from the top to the bottom of the page. The method 800 begins at operation 804 with the AP 502 and STA 504 associating 804 with one another. The associating may include RSNA establishment. For example, associating 804 may include one or more of the following: exchanging a number of parameters, authenticating with one another, conducting a 4-way handshake to establish keys that can be used for encrypting or protecting frames, and so forth. The STA 504 may receive a beacon frame of the AP 502 prior to associating and beginning the association process by transmitting an association request frame.

The method 800 continues at operation 806 with the STA 504 and/or the AP 502 determining that the STA 504 needs to reassociate with the AP 502 to change one or more parameters or configuration parameters that are being used to communicate with one another. Examples for why the STA 504 would reassociate are provided above and herein.

The method 800 continues at operation 808 with the STA 504 transmitting a reassociation request frame 808. The reassociation request frame 808 is not encoded.

The method 800 continues at operation 810 with the AP 502 determining whether the reassociation request 808 is from the STA 504 or a man-in-the-middle attack. If the AP 502 has not previously transmitted a security association (SA) query frame, then the AP 502 transmits a SA query frame. In some embodiments, when an STA 504 is reassociating with an AP 502 with which it is already associated with PMF, the AP rejects the reassociation request or association request with a refused-temporarily reason. The AP 502 initiates the SA Query mechanism and activates a timeout interval such as 2 seconds. The AP 502 will accept additional association requests or reassociation requests from same STA 504 only after the timeout interval expires and there has been no response from the STA 504.

In some embodiments, the AP 502 does only sends the SA query frame if the received (Re)Association Request frame is not protected and/or only if the AP 502 and STA 504 have not enabled sending protected (Re)Association Request frames. If the AP 502 determines at operation 810 not to send the SQ query frame 812, then the method 800 ends or skips to an operation for clean-up.

The method 800 continues at operation 814 with the STA 504 receiving the SA query frame. The STA 504 will not respond to the SA query frame if the STA 504 sent the reassociation request frame 808. The STA 504 waits a timeout duration and then transmits another reassociation request at operation 816. If the STA 504 did not send the reassociation request 808, then the STA 504 transmit the SA query response frame 818 to indicate to the AP 502 that it did not transmit a reassociation request.

The method 800 continues at operation 820 with decoding the reassociation requestion 816 or the SA query response frame 818. If the AP 502 receives the reassociation request 816, then the AP 502 transmits a reassociation response that begins a reassociation process. If the AP 502 receives the SA query response frame 818, then the AP 502 assumes that the first reassociation request 808 was not sent by the STA 504 or does not want to be pursued by the STA 504. The AP 502 resets the reassociation process so that the STA 504 would have to send a first reassociation request, wait for a SA query frame, wait a timeout period and then transmit another reassociation request frame.

Method 800 enables the AP 502 to use a SA Query mechanism to verify that the association or reassociation request frame is from the STA 504 and not by a man-in-the-middle attacker. The method 800 may be time consuming due to the timeout interval or duration after the SA query is transmitted.

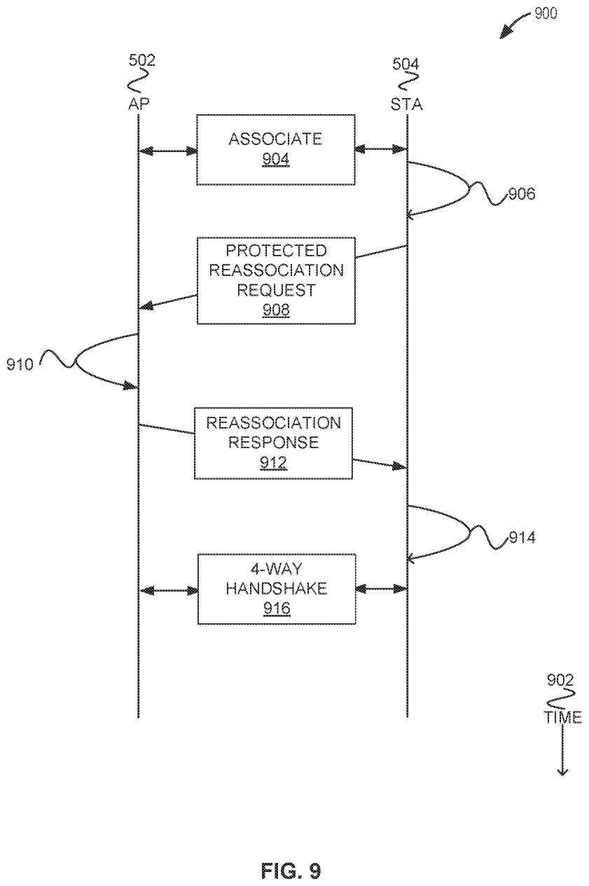

In some embodiments, the STA 504 is configured to de-authenticate from the AP 502 and then send a new association request frame to the AP 502. The time to de-authenticate and associate may create delays that are not acceptable for streaming applications such as Voice over Internet Protocol (VoIP). The delays are caused by the STA 504 and AP 502 having to perform authentication again, e.g., in accordance with Simultaneous Authentication of Equals (SAE), which generates a pairwise master key (PMK) on the AP 502 and the STA 504. The SAE is in accordance with IEEE 802.11r in accordance with some embodiments. The authentication opens the 802.1X port.) This process takes a second or longer. The method 900 described in FIG. 9 provides for not having the de-authentication process delays and not having the SA-query process delays, which may provide a better user-experience with shorter delays when a STA 504 associates or reassociates with an AP 502.

The AP 502 may be an apparatus of an AP 502. The STA 504 may be an apparatus of a STA 504. In some embodiments, the AP 502 is an AP affiliated with a multi-link device (MLD) and the reassociation frame or association frame is to reassociate or associate with another AP affiliated with the MILD on a different link. The method 800 may include one or more additional instructions. The method 800 may be performed in a different order. One or more of the operations of method 800 may be optional. The association frames may be used in a same or similar way as the reassociation frames.

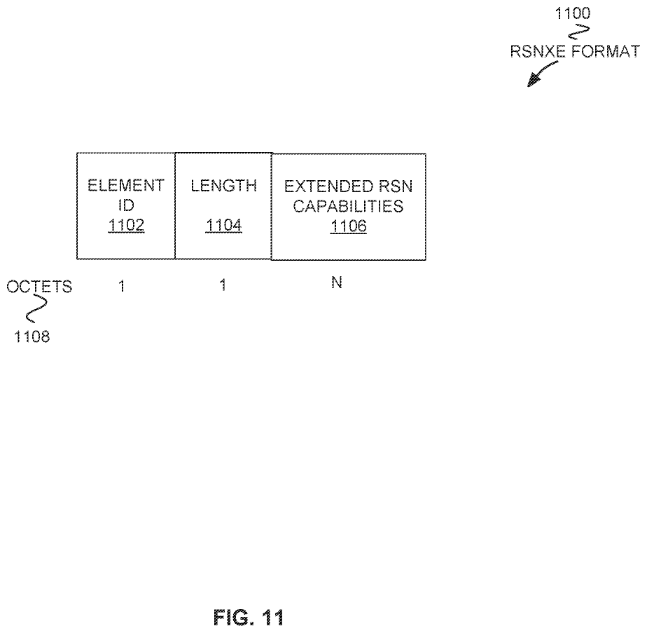

FIG. 9 illustrates a method 900 of fast association or reassociation with an AP 502, in accordance with some embodiments. Time 902 progresses from the top to the bottom of the page. The method 900 begins at operation 904 with the AP 502 and STA 504 associating 904 with one another. The associating may include RSNA establishment. For example, associating 904 may include one or more of the following: exchanging a number of parameters, authenticating with one another, conducting a 4-way handshake to establish keys that can be used for encrypting or protecting frames, and so forth. The STA 504 may receive a beacon frame of the AP 502 prior to associating and beginning the association process by transmitting an association request frame. The associating 904 may include a beacon frame or probe response frame that includes a robust security network (RSN) extension element (RSNXE) that includes an extended RSN capabilities subfield 1106 (see FIG. 11) that indicates that the AP 502 supports protected association request frames and reassociation request frames. The STA 504 may indicate in response to receiving the extended RSN capabilities 1106 subfield that the STA 504 supports protected association request frames and reassociation request frames as well. The RSNXE capabilities subfield 1106 is encoded by both the AP 502 and STA 504 and bit 6 (or another bit) is used by both, the STA 504 uses Bit 6 in a similar manner as the AP 502, indicating support for protected or encrypted reassociation request and association request frames.

In some embodiments, one of the bits in the extended ISSN capabilities 1106 subfield is set to indicate the support for the protected association request frames and reassociation request frames, e.g., bit 6, 7, or 8 may be used to indicate “Protected (Re)Association Request Support”. The AP 502 sets the “Protected (Re)Association Request Support” bit to 1 when it can decrypt and treat a protected (Re)Association Request, in accordance with some embodiments. In some embodiments a different bit is used. In some embodiments, if the STA 504 transmits a protected reassociation request frame or a protected association request frame, which are encrypted, and the AP 502 does not support the protected reassociation request frames and protected association request frames, then the AP 502 will not be able to decrypt the frame and synchronization with the STA 504 will be lost. In some embodiments, the protected reassociation request frame and protected association request frames are termed robust frames. In some embodiments, the robust management frames include disassociation, deauthentication, association request, reassociation request and robust action frames.

The method 900 continues at operation 906 with the STA 504 and/or the AP 502 determining that the STA 504 needs to reassociate with the AP 502 to change one or more parameters or configuration parameters that are being used to communicate with one another. Examples for why the STA 504 would reassociate are provided above and herein. The STA 504 determines whether the AP 502 supports PMFs, protected association request frames, and protected reassociation request frames. If the AP 502 does not, then the STA 504 does not continue with method 900. In some embodiments, after operation 904, the STA 504 is in a state 4 where the STA 504 is authenticated and associated with RSNA Established. The IEEE 802.1X Controlled Port is unblocked.

The method 900 continues at operation 908 with the STA 504 transmitting a protected reassociation request frame 908. The protected reassociation request frame 808 is encoded in accordance with the association 904 that was performed in operation 904. For example, management frame protection uses the pairwise transient key (PTK) and integrity group temporal key (IGTK) for encryption, which are determined with a 4-way handshake and the PMK established during authentication. The protected reassociation request frame is a protected association request frame, in accordance with some embodiments.

The method 900 continues at operation 910 with the AP 502 determining whether the protected reassociation request is valid and from the STA 504. The AP 502 determines if the protected reassociation request is valid based on the integrity check mechanism where the AP 502 can determine if the protected reassociation frame was transmitted by the authenticated STA 504 as otherwise there will be a message integrity check error.

And, if the AP 502 determines the protected reassociation request frame is valid and accepts the protected reassociation request frame, then the AP 502 does deletes the existing security keys with the STA 504 while keeping the PMKSA (e.g., PMK and PMKID). Since PMK is kept there is no need for a new authentication (e.g., IEEE 802.1X, SAE) with the STA 504. The keys deleted are temporal keys (TKs), Key encryption key (KEK), and Key confirmation key (KCK), in accordance with some embodiments. The keys deleted are a pairwise transient key security association (PTKSA), a group temporal key security association (GTKSA), an integrity group temporal key security association (IGTKSA), beacon integrity group temporal key security association (BIGTKSA), and temporal keys, in accordance with some embodiments.

The method 900 continues at operation 912 with the AP 502 encoding and transmitting a reassociation response frame, which may include parameters for association with the STA 504 and may include parameters that are in response to parameters included in the protected reassociation request frame of operation 908.

The method 900 continues at operation 914 with the STA 504 decoding the reassociation response frame of operation 912 and encoding and transmitting an acknowledgement to the reassociation response frame of operation 912. In some embodiments, the reassociation response frame is protected or encrypted. The STA 504 deletes the same or similar keys as the AP 502 deletes.

The method 900 continues at operation 916 with the AP 502 initiating a 4-way handshake upon receiving the acknowledgement of the reassociation response frame of operation 912. The AP 502 and STA 504 perform the 4-way handshake to reestablish the keys deleted in operation 910.

The AP 502 may be an apparatus of an AP 502. The STA 504 may be an apparatus of a STA 504. In some embodiments, the AP 502 is an AP affiliated with a MLD and the reassociation frame or association frame is to reassociate or associate with another AP affiliated with the MLD on a different link. The method 900 may include one or more additional instructions. The method 900 may be performed in a different order. One or more of the operations of method 900 may be optional. The association frames may be used in a same or similar way as the reassociation frames.

In some embodiments, the method 900 uses protected reassociation or association frames in accordance with a protect management frame mechanism. The method 900 enables the STA 504 to associate or reassociate with the AP 502 without having the timeout delay associated with the SA query mechanism and without disassociating with the AP 502 both of which are more time consuming then the method 900.

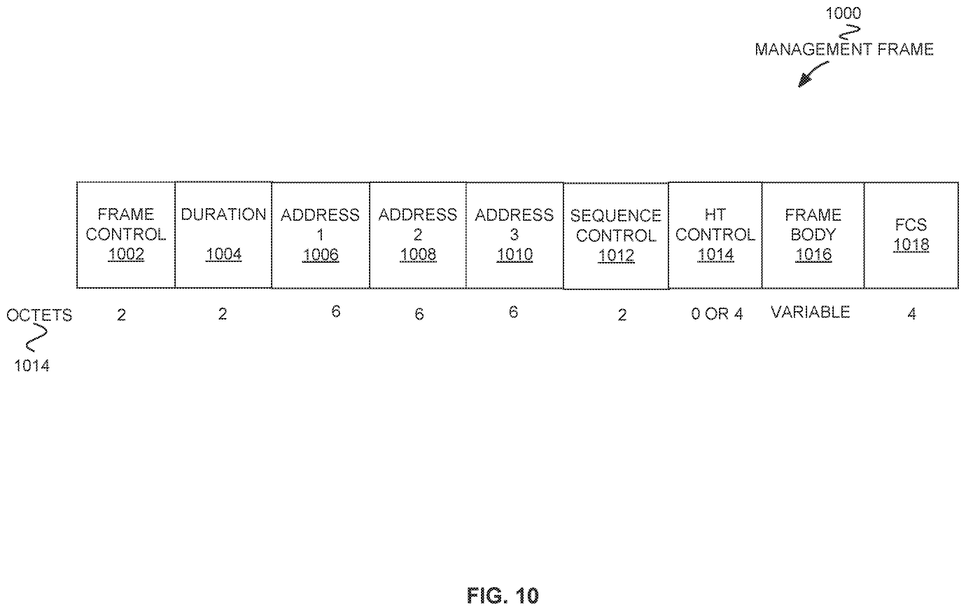

FIG. 10 illustrates a management frame 1000, in accordance with some embodiments. Illustrated in FIG. 10 is frame control 1002 field, duration 1004 field, address 1 1006 field, address 2 1008 field, address 3 1010 field, sequence control 1012 field, HT control 1014 field, frame 1016 field, FCS 1018 field, retry 1020 subfield, sequence number 1022 subfield, and octets 1014. The frame body 1016 may include the reassociation or association frame. In some embodiments, the management frame 1000 including the reassociation request frame or association request frame in the frame body 1016 field is encoded in a media access control (MAC) management protocol data unit (MMPDU) in a physical layer (PHY) protocol data unit (PPDU).

FIG. 11 illustrates robust security network extension element (RSNXE) format 1100, in accordance with some embodiments. The element ID 1102 field indicates an element ID for the RSNXE. The length 1104 field indicates a length of the RSNXE. The extended robust security network (RSN) capabilities 1106 field indicates the capabilities of the STA 504 or the AP 502 and, in some embodiments, indicates support for protected reassociation request frames and protected association request frames.

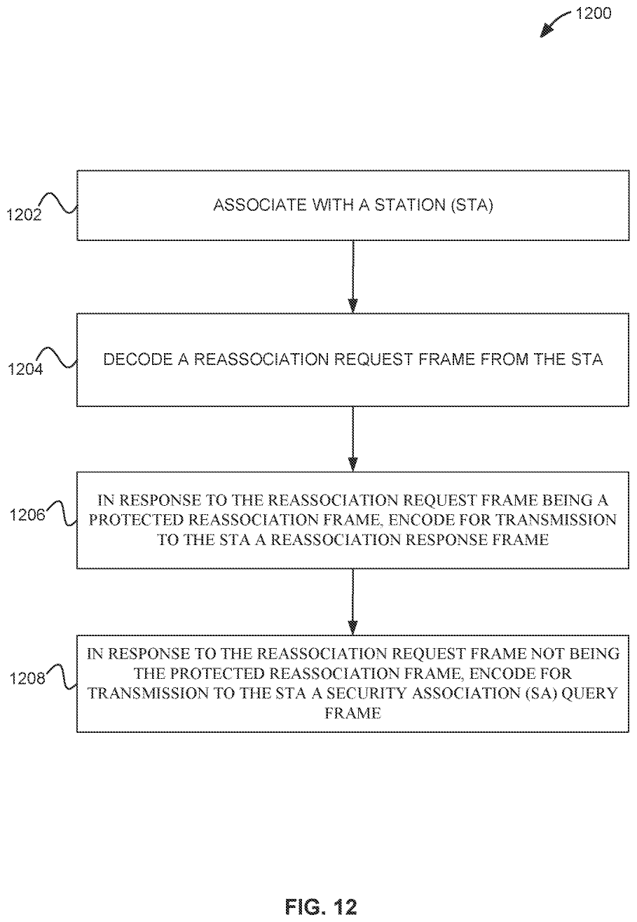

FIG. 12 illustrates a method 1200 of fast association or reassociation with an AP 502, in accordance with some embodiments. The method 1200 begins at operation 1202 with associating with a STA. For example, the AP 502 of FIGS. 8 and 9 may associate with the STA 504 at operations 804 and 904, respectively.

The method 1200 continues at operation 1204 with decoding a reassociation request frame from the STA. From example, the AP 502 of FIGS. 8 and 9 may decode a reassociation request at operations 808 and 908, respectively.

The method 1200 continues at operation 1206 with in response to the reassociation request frame being a protected reassociation frame, encode for transmission to the STA a reassociation response frame. For example, the AP 502 of FIG. 9 encodes for transmission to the STA the reassociation response frame at operation 912.

The method 1200 continues at operation 1208 with in response to the reassociation request frame not being the protected reassociation frame, encode for transmission to the STA a security association (SA) query frame. For example, the AP 502 of FIG. 8 encodes for transmission to the STA 504 the SA query frame at operation 812.

The method 1200 may be performed by an AP 502 or an apparatus of an AP 502. In some embodiments, the AP 502 is an AP affiliated with a MLD and the reassociation frame or association frame is to reassociate or associate with another AP affiliated with the MLD on a different link. The method 1200 may include one or more additional instructions. The method 1200 may be performed in a different order. One or more of the operations of method 1200 may be optional. The association frames may be used in a same or similar way as the reassociation frames.

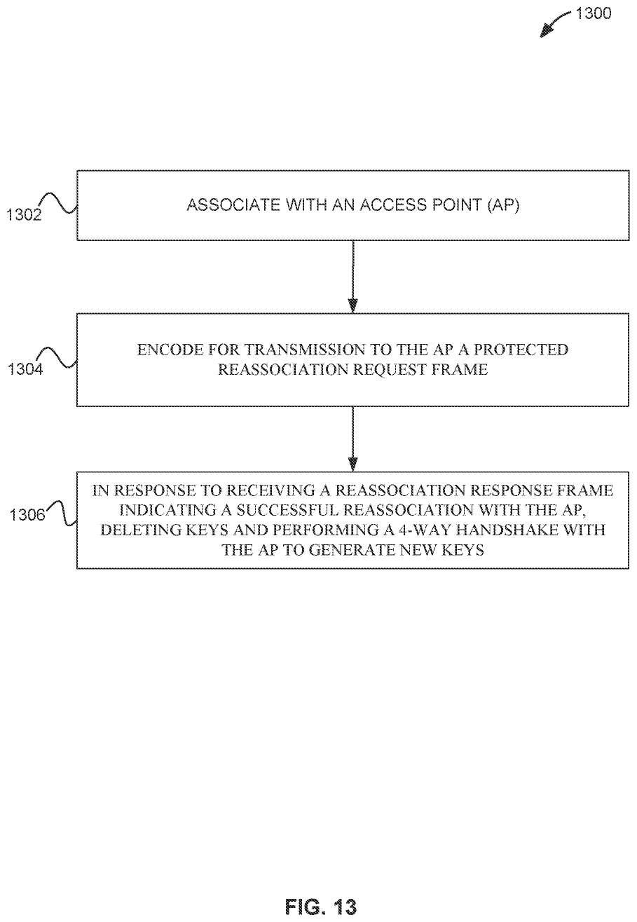

FIG. 13 illustrates a method 1300 of fast association or reassociation with an AP 502, in accordance with some embodiments. The method 1300 begins at operation 1302 with associating with an AP. For example, the STA 504 of FIGS. 8 and 9 may associate with the AP 502 at operations 804 and 904, respectively.

The method 1300 continues at operation 1304 with encoding for transmission to the AP a protected reassociation request frame. For example, the STA 504 transmits protected reassociation request frame at operation 908.

The method 1300 continues at operation 1306 with in response to receiving a reassociation response frame indicating a successful reassociation with the AP, deleting keys and performing a 4-way handshake with the AP to generate new keys. For example, the STA 504 of FIG. 9 performs a 4-way handshake at operation 916 with the AP 502 and deletes keys.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for an access point (AP), the apparatus comprising:
memory; and processing circuitry coupled to the memory, the processing circuitry configured to:
associate with a station (STA);
decode a reassociation request frame from the STA;
in response to the reassociation request frame being a protected reassociation frame, encode for transmission to the STA a reassociation response frame; and
in response to the reassociation request frame not being the protected reassociation frame, encode for transmission to the STA a security association (SA) query frame.

2. The apparatus of claim 1 wherein the in response to the reassociation request frame not being the protected frame further comprises in response to the reassociation request frame not being the protected frame, the STA having a valid security association, the STA having negotiated management frame protection, the reassociation request frame not indicating a fast basic service set (BSS) transition, the STA not having performed a successful Simultaneous Authentication of Equals (SAE) after the associate with the STA, and the AP having not timed out a SA query procedure.

3. The apparatus of claim 1 wherein the in response to the reassociation request frame being the protected reassociation frame further comprises: in response to receiving an acknowledgement frame acknowledging the STA receiving the reassociation response frame, deleting keys and performing a 4-way handshake to generate new keys.

4. The apparatus of claim 3 wherein the keys comprise one or more of the following group: a pairwise transient key security association (PTKSA), a group temporal key security association (GTKSA), an integrity group temporal key security association (IGTKSA), beacon integrity group temporal key security association (BIGTKSA), and temporal keys.

5. The apparatus of claim 1 wherein the processing circuitry is further configured to:
refrain from transmitting a SA query frame in response to receiving the protected reassociation request frame or a protected association request frame.

6. The apparatus of claim 1 wherein the association with the STA further comprises:
authenticate the STA in accordance with Institute of Electrical and Electronic Engineering (IEEE) 802.11 authentication; and
perform a robust security network association (RSNA) with the STA.

7. The apparatus of claim 1 wherein the processing circuitry is further configured to:
encode a frame comprising a field indicating the AP supports protected. reassociation and association frames.

8. The apparatus of claim 7 wherein the field is a subfield of an extended robust security network (RSN) capability field, and wherein the RSN capability field is a field in a RSN extension element (RSNXE).

9. The apparatus of claim 8 wherein the subfield of the RSN capabilities field is bit 6 and wherein the RSNXE is included in a beacon frame or a probe response frame.

10. The apparatus of claim 1 wherein the in response to the reassociation request frame being the protected reassociation frame further comprises: in response to the reassociation request frame being the protected reassociation frame, the STA having a valid security association with the AP, and the STA having negotiated management frame protection with the AP.

11. The apparatus of claim 1 wherein the processing circuitry is further configured to:
decode an association request frame from the STA; and
in response to the association request frame being a protected association frame, encode for transmission to the STA an association response frame; and
in response to the association request frame not being the protected reassociation frame, encode for transmission to the STA a SA query frame.

12. The apparatus of claim 11 wherein the in response to the association request frame not being the protected frame further comprises in response to the reassociation request frame not being the protected frame, the STA having a valid security association, the STA having negotiated management frame protection, the reassociation request frame not indicating a fast basic service set (BSS) transition, the STA not having performed a successful Simultaneous Authentication of Equals (SAE) after the associate with the STA, and the AP having not timed out a SA query procedure.

13. The apparatus of claim 1 wherein the STA is authenticated with the AP and wherein the reassociation request frame comprises reassociation parameters different than current association parameters.

14. The apparatus of claim 1 wherein the AP is an AP affiliated with a Multi-link device (MLD), wherein the reassociation request frame indicates another AP affiliated with the MLD, and wherein the processing circuitry is further configured to:
decode the reassociation request frame in a media access control (MAC) management protocol data unit (MMPDU) in a physical layer (PHY) protocol data unit (PPDU).

15. The apparatus of claim 1 further comprising: mixer circuitry to downconvert RF signals to baseband signals; and synthesizer circuitry, the synthesizer circuitry comprising one of a fractional-N synthesizer or a fractional N/N+1 synthesizer, the synthesizer circuitry configured to generate an output frequency for use by the mixer circuitry, wherein the processing circuitry is configured to decode the baseband signals, the baseband signals including the reassociation request frame.

16. The apparatus of claim 1 further comprising: mixer circuitry to down-convert RF signals to baseband signals; and synthesizer circuitry, the synthesizer circuitry comprising a delta-sigma synthesizer, the synthesizer circuitry configured to generate an output frequency for use by the mixer circuitry, wherein the processing circuitry is configured to decode the baseband signals, the baseband signals including the reassociation request frame.

17. A non-transitory computer-readable storage medium that stores instructions for execution by one or more processors of an apparatus for a station (STA, the instructions to configure the one or more processors to
associate with an access point (AP);
encode for transmission to the AP a protected reassociation request frame;
in response to receiving a reassociation response frame indicating a successful reassociation with the AP, deleting keys and performing a 4-way handshake with the AP to generate new keys.

18. The non-transitory computer-readable storage medium of claim 17, wherein the instruction further configure the one or more processors to:
decode a frame comprising a field indicating the AP supports protected reassociation and association frames.

19. A method performed by an apparatus for an access point (AP), the method comprising:
associating with a station (STA);
decoding a reassociation request frame from the STA; and
in response to the reassociation request frame being a protected reassociation frame, encoding for transmission to the STA a reassociation response frame; and
in response to the reassociation request frame not being the protected reassociation frame, encoding for transmission to the STA a security association (SA) query frame.

20. The method of claim 19 wherein the in response to the reassociation request frame not being the protected frame further comprises in response to the reassociation request frame not being the protected frame, the STA having a valid security association, the STA having negotiated management frame protection, the reassociation request frame not indicating a fast basic service set (BSS) transition, the STA not having performed a successful Simultaneous Authentication of Equals (SAE) after the associate with the STA, and the AP having not timed out a SA query procedure.
